(19) United States
(12) Patent Application Publication
(10) Pub. No.: US 2010/0308205 A1
(43) Pub. Date: Dec. 9, 2010

(54) METHOD FOR AUTO FOCUS SEARCHING OF OPTICAL MICROSCOPE

(75) Inventors: MING CHANG, CHUNG LI (TW); CHIH-TAO TSENG, CHUNG LI (TW); HSU-HUNG WEI, CHUNG LI (TW)

Correspondence Address: ROSENBERG, KLEIN & LEE, 3458 ELLICOTT CENTER DRIVE-SUITE 101, ELLICOTT CITY, MD, 21043, US

(73) Assignee: CHUNG YUAN CHRISTIAN UNIVERSITY, CHUNG LI (TW)

(21) Appl. No.: 12/563,395

(22) Filed: Sep. 21, 2009

(30) Foreign Application Priority Data
Jun. 5, 2009 (TW) 098118774

(51) Int. Cl. G02B 27/40

(52) U.S. Cl. 250/201.3

(57) ABSTRACT

A method for auto focus searching of optical microscopes is revealed. At first, sample a plurality of image signals according to a plurality of sampling positions. Then process the plurality of image signals to get a plurality of energy values. Next calculate a plurality of sharpness values of adjacent energy values and also calculate an absolute value corresponding to the sharpness value. Later check and find out a maximum value of the absolute values to get a sampling position corresponding to the image with the maximum value and use that position as the optimal focus position of the optical microscopes. By the sampling way, the energy values of the image signals are captured so as to save calculation time. Moreover, a sharpness value of adjacent energy value is also calculated so as to check the image captured at the best focus position quickly and reduce focus searching time of the optical microscope. Therefore, the focusing efficiency of the optical microscope is improved.

### BACKGROUND OF THE INVENTION

1. Field of Invention

The present invention relates to a method for auto focus searching, especially to a method for auto focus searching of optical microscopes.

2. Description of Related Art

The optical microscope uses objective lenses and ocular lens to magnify images of small objects. Thus researchers can observe appearance, size and internal structure of small objects for further study and analysis. Along with development of optical lenses, people can explore the microscopic world. Through a microscope, scientists start to study the microscopic field and apply it to various fields such as medicine, biology, geology, mineralogy, botany, material science, metallurgy, food test, criminal investigation and other researches. Nothing can replace it and the microscopes have become essential scientific instruments.

Along with development of digital signal technology of images, optical microscopes are used in combination with CCD (Charge-coupled Device) camera to test products and measure objects more quickly. For example, the measurement of roughness and smoothness of chips, size and co-planarity of solder ball and solder bump, size and height of spacers during manufacturing processes of color filters and cells of LCD (liquid crystal display), end-face of the optical fiber, and surface of micro-optics, or observation and analysis of biological cells, all take lots of time and these repeated operations need to be simplified through automatic focusing way. With assistance of high-efficiency auto-focusing system, samples are analyzed and tested quickly and automatically.

Auto-focus technology plays an important role in scanning microscope systems. Generally, the algorithm of auto-focus measures focusing curve by function. The auto-focus technology includes two groups-active and passive. The passive group is divided into two types-sharpness measure and focus searching method while the sharpness measure uses frequency transform or spatial domain.

The active way uses auxiliary light sources such as ultrasonic wave, lasers or infrared rays that projects light to a surface of objects to be detected. Then returning signals are received by sensors and the reflection time is measured. Or the distance between the light source and the object is calculated by Triangulation so as to adjust the distance between the object and the camera for focusing. The advantage of the passive way is short focusing time. And even under dark or low light intensity condition, the focusing is still achieved. On the other hand, the disadvantages are as followings: (1) high cost: range finders are quite expensive and the cost is proportional to instrument resolution. (2) difficult installation: unable to provide a design with a common optical axis, things within the camera range are not in focus and this causes errors. (3) large volume: the distance between samples and lenses is quite short in an inspection system of semiconductor or other optoelectronic industry so that the focusing system with large volume is difficult to be applied to machines in the system.

Passive autofocus systems determine the focus by using CCD or other sensors to detect light beams reflected from the surface of the object to the lens for getting digital data, sharpness value or contrast. Then together with focus searching method, the focusing is achieved. The advantage of passive focus is that there no plug-in instruments that occupy space and image capturing and processing are performed directly by CCD. Yet the shortcomings are: (1) long processing time: it takes quite a lot time to check the focus repeatedly. Thus there is a need to have an algorithm with faster calculation speed. (2) sufficient light is required. When there is no enough light, the distance is not measured precisely.

Most of techniques available in the domestic market are passive auto-focus. By the CCD of the system for image capture, light intensity is converted into measurable voltage signals. By a suitable time series, one dimensional voltage signal represents two dimensional image. Then in combination with an image processing software and focus algorithm, the best focus position is obtained. The cost of the passive auto-focus machines is low and the machines can find the best focus position by only sufficient light. However, the processing time of the passive auto-focus machines is longer and this has negative effects on focusing efficiency. Once the processing (calculation) time of the passive auto-focus can be shortened, the focusing efficiency of the passive auto-focus machines can be increased.

Thus there is a need to provide an auto focus searching method for optical microscopes that simplified calculation processes of auto-focusing so as to increase auto-focusing speed of the optical microscopes and solve above problems.

### SUMMARY OF THE INVENTION

Therefore it is a primary object of the present invention to provide a method for auto focus searching of optical microscopes in which a plurality of energy values of a plurality of image signals are captured by a sampling way so that the calculation time is shortened. Moreover, a sharpness value of adjacent energy value is also calculated so as to check the image captured at the best focus position quickly and reduce focus searching time of the optical microscope. Thus the focusing efficiency of the optical microscope is improved.

In order to achieve above object, the method for auto focus searching of optical microscopes includes the following steps. In the beginning, sample a plurality of image signals according to a plurality of sampling positions. Then process the plurality of image signals to get a plurality of corresponding energy values. Next calculate sharpness values of adjacent energy values. Then calculate an absolute value corresponding to each sharpness value and find out a maximum value among these absolute values. The maximum value corresponds to one of the plurality of images. At last, according to the image signal corresponding to the maximum value, the corresponding sampling position is obtained and is used as the best focus position of the optical microscope. The calculation time is shortened by the sampling way that captures a plurality of energy values of a plurality of image signals. Moreover, a sharpness value of adjacent energy value is also calculated so as to check the image captured at the best focus position quickly and further reduce focus searching time of the optical microscope. Therefore, the focusing efficiency of the optical microscope is improved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart of an embodiment according to the present invention;

FIG. 2 is a flow chart showing detailed steps of image signals of an embodiment according to the present invention.

### DETAILED DESCRIPTION OF THE PREFERRED EMBODIMENT

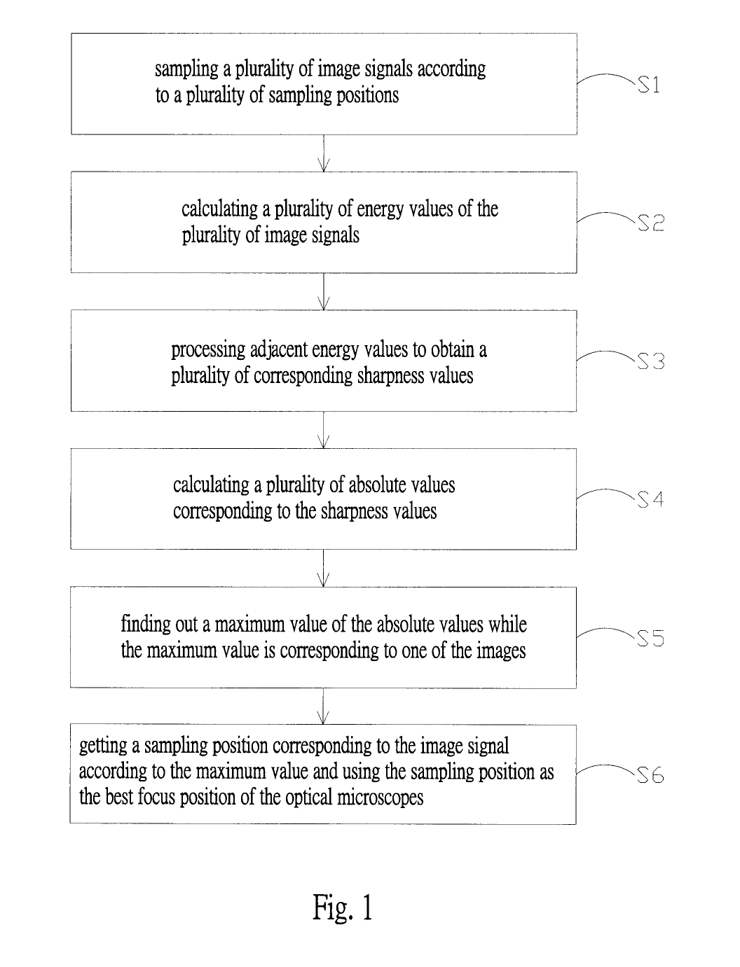

Refer to FIG. 1, a flow chart of an embodiment according to the present invention is revealed. A method for auto focus searching of optical microscopes of the present invention includes the following steps. In the beginning, run the step S1, sample a plurality of image signals according to a plurality of sampling positions. Then take the step S2, calculate (process) the plurality of image signals to get a plurality of energy values correspondingly. Next run the step S3, calculate a plurality of sharpness values of adjacent energy values. The plurality of sharpness values is obtained by Pearson's algorithm. Later take the step S4, calculate a plurality of absolute values corresponding to the plurality of sharpness values. Then run the step S5, check out the absolute values to find out a maximum value that corresponds to one of the plurality of images. At last, run the step S6, learn a sampling position according to the image signal corresponding to the maximum value and use the sampling position as a focus of an optical microscope. A plurality of energy values of the image signals is captured by the sampling way so that the processing time is shortened. Moreover, a sharpness value of adjacent energy value is calculated so as to find out the image captured at the optimal focus. Thus the searching time of the optical microscope for the optimal focus is reduced and the focusing efficiency of the optical microscope is increased.

Conventional spectrum analysis defines a physical system in the linear-response. However, various phenomena in nature belong to non-stationary signals and temporary states that are also important in signal processing. But the spectrum analysis is unable to be applied to analyze these effectively. Moreover, all signals being processed should be recognized on the time they occur. Both amplitude and frequency should be combined with time so as to define signal characteristic. Thus the present invention uses Hilbert transform to show an energy-frequency-time distribution, designated as the Hilbert spectrum. For analyzing non-linear and non-stationary signals, Hilbert transform provides better analysis results. After being processed by Hilbert transform, signal analysis is easier and the analysis precision is improved.

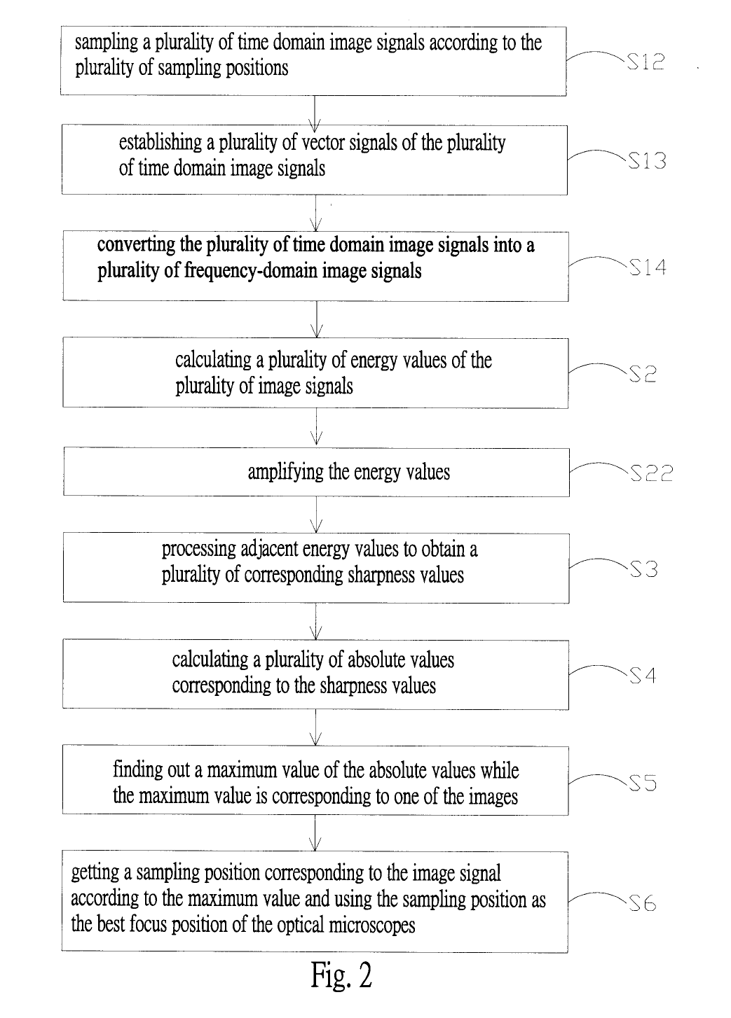

Refer to FIG. 2, firstly, take the step S12, sample a plurality of time domain image signals of a plurality of image signals. Then run the step S14, convert the plurality of time domain image signals into a plurality of frequency domain image signals and generate a plurality of energy values according to the frequency domain image signals. The energy values are got by Hilbert algorithm. The step S12 further includes a step S13, establish a plurality of vector signals of the plurality of time domain image signals. Thus in the step S14, these vector signals are converted into a plurality of frequency domain image signals. Moreover, after the step S2, the method further includes a step S22, amplify the plurality of energy values. The amplification way is to square the energy value.

In the present invention an image signal or time series X(t) is sampled. After being processed by Hilbert Transform, a plurality of time series Z(t) is obtained. Z(t) is represented by an equation: Z(t)=X(t)+iY(t). The plurality of time series correspond to an amplitude a(t) that is represented by: a(t)=√(X²(t)+Y²(t)). The discrete Hilbert Transform is represented as: Y(n)=IDFT(H(m)·DFT(X(n))), wherein DFT is discrete Fourier transformation and IDFT means inverse discrete Fourier transform.

DFT is represented by the following equation:

$$DFT ( X ( n ) ) = {\sum }_{n = 1}^{N} X ( n ) \cdot {e}^{- i 2 π \frac{( n - 1 ) ( m - 1 )}{N}} ,$$

IDFT is represented by the following equation:

$$IDFT ( X ( m ) ) = \frac{1}{N} {\sum }_{m = 1}^{N} X ( m ) \cdot {e}^{- i 2 π \frac{( n - 1 ) ( m - 1 )}{N}} ,$$

H is a vector whose value is represented as:
H(m)=1 for m=1, (n/2)+1
2 for m=2, 3, . . . (n/2)
0 for m=(n/2)+2, . . . , n
   Through one-dimensional Hilbert Transform, frequency signal of the image energy is obtained. Each time domain image signal f (x, y) k captured by the image system establishes a vector c Z according to gray values of images. c Z is a vector with a fixed interval d, c=1, 2, . . . , C and is represented as followings:

$${Z}_{1} = {f}_{k} ( 1 , j )$$

$${Z}_{2} = {f}_{k} ( 1 + d , j )$$

$$⋮$$

$${Z}_{c} = {f}_{k} ( ( c - 1 ) \cdot d , j )$$

Wherein C=int(image_width/d−1), and j=1, 2, 3 . . . image_height. By such sampling way, there is no need to process data of the whole image so that the processing time is shortened dramatically. Then the c V is converted into frequency-domain (image) signal by the Hilbert Transform. Next take the amplitude of the signal and square it. The step of square is to increase the variance for convenience of checking the best focusing. The vector is represented as:

$${H}_{1} = {( {a}_{1} )}^{2}$$

$${H}_{2} = {( {a}_{2} )}^{2}$$

$$⋮$$

$${H}_{c} = {( {a}_{c} )}^{2}$$

Next construct a series of Hilbert Power Spectrum Vector (HPSV)

$$\begin{matrix}{HPSV}_{k} = H 1 \\ = H 2 \\ ⋮ \\ = H C\end{matrix}$$

Each captured image has a corresponding Hilbert Power Spectrum Vector. Then by Person correlation analysis, correlation is achieved by comparison of energy between two images while r is the sharpness value and is represented by the following equation:

$$r = \frac{\sum X Y - \frac{\sum X \sum Y}{n}}{\sqrt{[ \sum X 2 - \frac{{( \sum X )}^{2}}{n} ] [ \sum Y 2 - \frac{{( \sum Y )}^{2}}{n} ]}}$$

r Ranges from 1 to −1. Thus by using an absolute value of r−|r|, the correlation between energy of images is easy to learn. X and Y are variance of two samples and n means data amount of the sample. When |r| is closer to zero, the sharpness value is getting smaller. When |r| is larger, the sharpness value is larger. According to the property, when |r| is the extreme value of the correlation among continuous images captured, k represents the kth image captured and is the best focus position. The best focus position is represented by the equation: Best_focus=max|r|. While calculating the correlation r, make 1X=HPSV₁, Y=HPSVₖ, n=image_height, X is reference data and is correlated to various k images of Y. That means the Hilbert Power Spectrum Vector of the first image captured is used as reference and is compared with the HPSV of the kth image so as to get the extreme value |rₖ|. The best focus position falls in the kth image.

The focus method of the present invention can be applied to different optical microscopes such as fluorescence microscopes, metallurgical microscopes, and interferometric microscope etc. Take the fluorescence microscope as an example, it is a device used to observe cellular activities, and internal cellular structure. As to the metallurgical microscope, it is suitable to observe the microscopic surfaces of non-transparent objects. In combination with high-speed auto-focus system, the repetitive and complicated operations of optical microscopes are simplified so that the work efficiency is improved.

The interferometric microscopes now available on the market have various modules of focus systems. If users want to simplify the system and reduced the cost without optional auxiliary equipments and complicated light paths, the image capture by a single CCD can achieve the objects. By high-speed, high-accuracy sharpness algorithm, check positions of interference images roughly to set predetermined scanning range. Then through high-precision PZT (PbZrTiO3) scanning, the three-dimensional (3D) measurement of the object is finished. Thus according to the method for auto focus searching of optical microscopes of the present invention, the calculation is simplified so as to improve auto-focus efficiency of the optical microscope.

In summary, a method for auto focus searching of optical microscopes according to the present invention consists of a plurality of steps. Firstly, sample a plurality of image signals according to a plurality of sampling positions and calculate a plurality of energy values of the plurality of image signals. Next calculate adjacent energy values to get corresponding sharpness values and find out a maximum value of the absolute values corresponding to the sharpness values. The maximum value corresponds one of the plurality of images. Thus check out a position of the image signal corresponding to the maximum value. By the sampling way, the energy values of the plurality of the image signals are captured so as to save calculation time. Moreover, a sharpness value of adjacent energy value is also calculated so as to check the image captured at the best focus position quickly and reduce focus searching time of the optical microscope. Therefore, the focusing efficiency of the optical microscope is improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for auto focus searching of optical microscopes comprising the steps of:
sampling a plurality of image signals according to a plurality of sampling positions,
calculating a plurality of energy values of the plurality of image signals,
processing adjacent energy values to obtain a plurality of corresponding sharpness values,
calculating a plurality of absolute values corresponding to the sharpness values,
finding out a maximum value of the absolute values while the maximum value is corresponding to one of the images, and
getting a sampling position corresponding to the image signal according to the maximum value and using the sampling position as the best focus position of the optical microscopes.

2. The method as claimed is claim 1, wherein the step of sampling a plurality of image signals according to a plurality of sampling positions further includes the steps of:
sampling a plurality of time domain image signals according to the plurality of sampling positions, and
converting the plurality of time domain image signals into a plurality of frequency-domain image signals and generating the plurality of energy values according to the plurality of frequency-domain image signals.

3. The method as claimed is claim 2, wherein after the step of sampling a plurality of time domain image signals according to the plurality of sampling positions, the method further includes a step of: establishing a plurality of vector signals of the plurality of time domain image signals so that in the step of converting the plurality of time domain image signals into a plurality of frequency-domain image signals, the plurality of vector signals are converted into the plurality of frequency domain image signals.

4. The method as claimed is claim 2, wherein in the step of generating the plurality of energy values according to the plurality of frequency-domain image signals, the plurality of energy values is generated by Hilbert algorithm.

5. The method as claimed is claim 1, wherein in the step of processing adjacent energy values to obtain a plurality of corresponding sharpness values, the plurality of corresponding sharpness values is obtained by Pearson's algorithm.

6. The method as claimed is claim 1, wherein after the step of calculating the plurality of energy values of the plurality of image signals, the method further includes a step of amplifying the energy values.

7. The method as claimed is claim 6, wherein in the step of amplifying the energy values, the energy value is squared.
